(19) United States
(12) Patent Application Publication
(10) Pub. No.: US 2008/0191511 A1
(43) Pub. Date: Aug. 14, 2008

(54) Window Shade Device

(76) Inventors: Leon Neuer, Petach Tikva (IL); Uzi Kupfer, Petach Tikva (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/815,867

(22) PCT Filed: Feb. 9, 2006
(86) PCT No.: PCT/IL2006/000177

§ 371 Date: Aug. 9, 2007

Related U.S. Application Data
(60) Provisional application No. 60/651,979, filed on Feb. 14, 2005.

(51) Int. Cl. B60J 11/02; A47G 5/02

(52) U.S. Cl. 296/98; 160/239

(57) ABSTRACT

A window shade device according to the present invention serving for a significant decrease in the rising of temperature within a vehicle caused by the greenhouse effect includes a multiple-ply sheet that is the main component of the window shade device and has the required qualities of mechanical strength, low weight, good reflection of solar y radiation, and self-rolling capability. These qualities are granted to the shading sheet by its structure and y manufacturing process. The shading sheet is composed as a multiple-ply sheet, with the plies composed of materials granting most of the required qualities and tension differences, including the self-rolling capability for rolling around one single axis. The multiple-ply sheet is stored in a container that can have low aerodynamic resistance, assembled in a suitable location on a vehicle or stationary structure. The window shade device according to the present invention is constructed in such a manner that one model will have the capability of covering practically all makes of cars. The window shade device according to the present invention remains on the roof of a car both when it is being driven and when the car is in parked position.

### FIELD AND BACKGROUND OF THE INVENTION

The present invention relates a window/roof shade device, and in particular to a self-rolling vehicles car window/roof shade device.

When vehicles are exposed to the sun, the passenger compartments heat up quickly to high temperatures, as the result of a greenhouse effect.

Greenhouse effect is a common effect that occurs mostly in closed places into which solar radiation passes through windows of translucent materials such as glass.

When ultraviolet (UV) or visible light strikes dark material it is converted into infrared light which is long wave electromagnetic radiation. The window's glass is opaque to that long wave electromagnetic radiation, trapping it, and raising the temperature of the dark material, thus also raising the temperature of the air within the closed place, such as a greenhouse or car. This effect is what is known as greenhouse effect.

This heat can be dangerous to adults, and more so for infants, children and pets. People with conditions such as high blood pressure and heart and lung disease are also vulnerable. In fact, no one should enter a car which is above 45° C. (Celsius). However, most people do. The temperature on an average summer day in temperate climate zones is about −28° C. and on these days the inner temperature of a car can climb to 65° C. Even when sitting in the sun when the outside temperature is 22° C., a car will heat up to 50° C. within 2 hours and to 54° C. within 3 hours. Fresh produce, frozen foods, ice cream, etc are also affected by the heat.

There is need for a window shade device in land vehicles such as private vehicles, trucks, agricultural machinery, and trains, as well as naval vessels, aircraft, and stationary structures such as homes and offices.

Until now, efforts to alleviate this problem have not been very successful. One can find auto accessories such as folding shades for the front dashboard or inner blinds to cover the windows. Vehicle covers are also available on the market. All of these items have a marginal effect in reducing the build-up of heat in the cabin of a vehicle, and their operation, and particularly their retraction or folding renders their use very limiting. Examples of solutions proposed for these limits can be found in the following three patents:

A cover for the cab portion of an automobile is described in U.S. Pat. No. 4,842,324, 1989 of Carden. FIG. 1a of the prior art illustrates a car covered with a cover for the cab portion of a car 10. The cover includes a four sided structure, and the patent teaches that the cover can be made of polyester having a suede inner surface and aluminum coated outer surface which reflects the rays of the sun in a random manner. This solution has the following drawbacks: It takes a great deal of time and effort to put on and remove, gathers dust, takes up a large part of a car's trunk, and can be stolen quite easily.

A roll-up environmental elements protector for a car is described in U.S. Pat. No. 5,516,181, 1996 of Thompson. FIG. 1b of the prior art illustrates a car covered with an environmental elements protector 20. The environmental elements protector includes a rectangular main section and side flaps, rolling on a cylinder. This environmental elements protector can be rolled up around the cylinder, which can then be stored in the vehicle's trunk. While this design provided a storable cover, it was inconvenient and cumbersome to use, because after use, the cover had to be removed from the vehicle roof and manually rolled up. This device is quite heavy and not easy to handle, especially for people who are not particularly tall.

A retractable cover for a car is described in U.S. Pat. No. 6,012,759, 2000 of Adamek. FIG. 1c of the prior art illustrates a car covered with a retractable vehicle cover 30. The retractable vehicle cover includes a least one cover reel and at least one extension line reel disposed within housing. The cover is wrapped around cover reel. The patent teaches that the retractable vehicle cover can be rolled by means of a helical spring.

The prior art does not teach or suggest the production or use of a sheet that can provide good coverage of all of a vehicle's windows, inside and outside, from solar radiation, and as a facilitator for removal of sleet and ice that accumulates on a parking vehicle, which has a directional self-rolling quality that prevents the need to apply a rolling moment from another source such as a manual moment, or a moment generated by a spring or a motor.

There is thus a widely recognized need for, and it would be highly advantageous to have, a shielding device that can provide good coverage of all of vehicles windows, inside and outside, from solar radiation, and as a facilitator for removal of sleet and ice that accumulates on a parking vehicle, which has a directional self-rolling quality by covering the entire windshield and back window whereas the prior art leaves significant portions of the windows exposed to the sun resulting in rapid heat build-up.

### SUMMARY OF THE INVENTION

It is an object of the present invention to provide the window shade device for vehicle which can be quickly and easily deployed and removed and dismantled.

According to the present invention there is provided a thin multiple-ply sheet for a window shade device having a first geometric axis and a second perpendicular geometric axis, having a self-rolling capability, having an upper surface and a bottom surface which substantially blocks the passage of solar radiation in the ranges of ultraviolet and visible light, the multiple-ply sheet including: (a) a first sheet of material, having a thickness value, having homogenous first tension in the first geometric axis direction, and having homogenous second tension in the second geometric axis direction; and (b) a second sheet of material, having a thickness value substantially connected to the first sheet of material having homogenous first tension in the first geometric axis direction, and having homogenous second tension in the second geometric axis direction, wherein the first tension of the first sheet of material is substantially identical to the first tension of the second sheet of material, and wherein the second tension of the first sheet of material is larger than the second tension of the second sheet of material.

According to still further features in the described preferred embodiments the first tension of the first sheet of material is substantially zero.

According to still further features in the described preferred embodiment the thin multiple-ply sheet for a window shade device further including: (c) a third sheet of material, having a thickness value, substantially connected to the second sheet of material, having an external surface.

According to still further features in the described preferred embodiment the thin multiple-ply sheet for a window shade device further including: (d) a fourth sheet of material, having a thickness value, substantially connected to the first sheet of material, having an external surface; and (e) a layer of an anti-UV compound, disposed on the third sheet of material's external surface.

According to still further features in the described preferred embodiment the thin multiple-ply sheet for a window shade device further including: (d) a fourth sheet of material, having a thickness value, substantially connected to the first sheet of material, having an external surface; and (e) a layer of an anti-UV compound, disposed on the fourth sheet of material's external surface.

According to still further features in the described preferred embodiment the third sheet of material's having a thickness value is at least three times larger than the first sheet of material's a thickness value.

According to still further features in the described preferred embodiment the second sheet of material, is made of a vaporized dulled-aluminum coating layer, and wherein the first, third, and fourth sheets of material are made of polyethylene terephthalate.

According to still further features in the described preferred embodiment the first sheet of material, and the fourth sheet of material's thickness value are at least 10 microns, and at most 20 microns.

According to another preferred embodiment of the present invention there is provided a window shade device including: (a) a thin multiple-ply sheet for a window shade device having first geometric axis and second perpendicular geometric axis, having self-rolling capability, having four sides, having an upper surface and a bottom surface, which substantially blocks the passage of solar radiation in the spectrum of ultraviolet and visible light, the multiple-ply sheet including: (i) a first sheet of material, having thickness value, having homogenous first tension in the first geometric axis direction, and having homogenous second tension in the second geometric axis direction; and (ii) a second sheet of material, having thickness value substantially connected to the first sheet of material having homogenous first tension in the first geometric axis direction, and having homogenous second tension in the second geometric axis direction, wherein the first tension of the first sheet of material is substantially identical to the first tension of the second sheet of material, and wherein the second tension of the first sheet of material is larger than the second tension of the second sheet of material; (iii) a third sheet of material, having a thickness value, substantially connected to the second sheet of material, having an external surface; (iv) a fourth sheet of material, having a thickness value, substantially connected to the first sheet of material, having an external surface; and (v) a layer of an anti-UV compound, disposed on the third sheet of material's external surface; (b) a container containing the thin multiple-ply sheet and enabling pulling part of the sheet out, and returning the sheet into the container by self-rolling, including: (i) walls granting the container the form of an elongated cylinder; and (ii) an axis disposed within the container, on which the thin multiple-ply sheet is rolled.

According to still further features in the described preferred embodiment the window shade device further including: (c) at least one arm, wherein the arm enables the connection of the container to a stationary structure.

According to still further features in the described preferred embodiment the window shade device further including: (c) at least one connector, disposed on the thin multiple-ply sheet, wherein the connector enables the thin multiple-ply sheet to grip the vehicle; and (d) a lid connected to the container enabling opening and closing of the container, wherein the form of the lid suits the form of the container and wherein when the lid is closed it applies force to the thin multiple-ply sheet, preventing the possibility of the force of wind pulling the sheet out of the container.

According to still further features in the described preferred embodiment the aerodynamic drag coefficient, is at most 0.1, when the window shade device is assembled to a forward-moving vehicle.

According to still further features in the described preferred embodiment the window shade device further including: (e) a first additional thin multiple-ply sheet disposed on the thin multiple-ply sheet; and (f) a second additional thin multiple-ply sheet disposed on the thin multiple-ply sheet, wherein the geometric shape of the thin multiple-ply sheet, the first additional thin multiple-ply sheet, and the second additional thin multiple-ply sheet, when open, is suitable for full coverage of a vehicle window and wherein the self-rolling direction of the first additional thin multiple-ply sheet, and second additional thin multiple-ply sheet, is inverse to the self-rolling direction of the thin multiple-ply sheet.

According to still further features in the described preferred embodiment at least one side of the thin multiple-ply sheet has a cylindrical shape.

According to still further features in the described preferred embodiment the window shade device further including: (g) a central strengthening rod disposed on the thin multiple-ply sheet; (h) a first side strengthening rod disposed on the first additional thin multiple-ply sheet; and (i) a second side strengthening rod disposed on the second additional thin multiple-ply sheet.

According to still further features in the described preferred embodiment the first tension of the first sheet of material is substantially zero.

According to still further features in the described preferred embodiment the third sheet of material's a thickness value is at least three times larger than the first sheet of material's thickness value.

According to still further features in the described preferred embodiment the second sheet of material, is made of a vaporized dulled-aluminum coating layer, and wherein the first, the third, and the fourth sheets of material are made of polyethylene terephthalate.

According to still further features in the described preferred embodiment the first sheet of material and the fourth sheet of material's thickness value are at least 10 microns, and at most 20 microns.

According to still further features in the described preferred embodiment the thin multiple-ply sheet for a window shade device has a diameter, wherein the diameter is at most 17 millimeters, when the multiple-ply sheet is completely rolled around the axis and disposed within the container.

According to still further features in the described preferred embodiment the window shade device has a mass, wherein the mass is at most 1 kilogram.

According to still further features in the described preferred embodiment the window shade device further including: (c) at least one rotary connector, wherein the rotary connector enables the connection of first the window shade device to a second window shade device.

According to still further features in the described preferred embodiment the window shade device further including: (c) at least one thin magnetic sheet, disposed on the container, wherein the thin magnetic sheet enables the container to grip the vehicle; and (d) a lid connected to the container enabling opening and closing of the container, wherein the form of the lid suits the form of the container and wherein when the lid is closed it applies force to the thin multiple-ply sheet, preventing the possibility of the force of wind pulling the sheet out of the container.

According to another preferred embodiment of the present invention there is provided a method of preventing greenhouse effect inside vehicles and buildings, including the steps of: (a) providing a user with a window shade device including: (i) a thin multiple-ply sheet for a window shade device having a first geometric axis and a second perpendicular geometric axis, having a self-rolling capability, having four sides, having an upper surface and a bottom surface, which substantially blocks the passage of solar radiation in the ranges of ultraviolet and visible light, wherein the thin multiple-ply sheet includes: (A) a first sheet of material, having a thickness value, having homogenous first tension in the first geometric axis direction, and having homogenous second tension in the second geometric axis direction ; and (B) a second sheet of material, having a thickness value substantially connected to the first sheet of material having homogenous first tension in the first geometric axis direction, and having homogenous second tension in the second geometric axis direction, wherein the first tension of the first sheet of material is substantially identical to the first tension of the second sheet of material, and wherein the second tension of the first sheet of material is larger than the second tension of the second sheet of material; (C) a third sheet of material, having a thickness value, substantially connected to the second sheet of material, having an external surface; (D) a fourth sheet of material, having a thickness value, substantially connected to the first sheet of material, having an external surface; and (E) a layer of an anti-UV compound, disposed on the third sheet of material's external surface; (ii) a container containing the thin multiple-ply sheet enabling pulling part of the sheet from and returning the sheet into the container by self-rolling including: (A) walls granting the container the form of an elongated cylinder; and (B) an axis disposed within the container, upon which the thin multiple-ply sheet is rolled; (iii) at least one arm, wherein the arm enables the connection of the container to a vehicle; (iv) at least one connector, disposed on the thin multiple-ply sheet, wherein the connector enables the thin multiple-ply sheet to grip the vehicle; and (v) a lid connected to the container enabling opening and closing of the container, wherein the form of the lid suits the form of the container and wherein when the lid is closed it applies force to the thin multiple-ply sheet, preventing the possibility of the force of wind pulling the sheet out of the container, when the vehicle is in parked position; (b) connecting the window shade device to the vehicle, outside of the vehicle; (c) pulling the thin multiple-ply sheet from the container and covering at least part of one of the vehicle's windows; (d) connecting the pulled end of the thin multiple-ply sheet to the vehicle; (e) closing the lid with force over the pulled thin multiple-ply sheet; (f) opening the lid to a position enabling free motion of the thin multiple-ply sheet into the container; (g) releasing the connection of the pulled end of the thin multiple-ply sheet from the vehicle; and (h) self-rolling of the thin multiple-ply sheet into the container, wherein the user applies a restraining force to the multiple-ply sheet to prevent rolling too fast.

According to still further features in the described preferred embodiment the connector aerodynamic drag coefficient, is at most 0.1 when the window shade device is assembled to a forward-moving vehicle.

According to still further features in the described preferred embodiment the window shade device further including: (vi) a first additional thin multiple-ply sheet disposed on the thin multiple-ply sheet; and (vii) a second additional thin multiple-ply sheet disposed on the thin multiple-ply sheet, wherein the geometric shape of the thin multiple-ply sheet, the first additional thin multiple-ply sheet, and second additional thin multiple-ply sheet, when open, is suitable for full coverage of a vehicle window and wherein the self-rolling direction of the first additional thin multiple-ply sheet, and second additional thin multiple-ply sheet, is inverse to the self-rolling direction of the thin multiple-ply sheet.

According to still further features in the described preferred embodiment at least one side of the thin multiple-ply sheet has a cylindrical shape.

According to still further features in the described preferred embodiment the window shade device further including: (viii) a central strengthening rod disposed on the thin multiple-ply sheet; (ix) a first side strengthening rod disposed on the first additional thin multiple-ply sheet; and (x) a second side strengthening rod disposed on the second additional thin multiple-ply sheet.

According to still further features in the described preferred embodiment the first tension of the first sheet of material is substantially zero.

According to still further features in the described preferred embodiment the third sheet of material's thickness value is at least three times larger than the first sheet of material's thickness value.

According to still further features in the described preferred embodiment the second sheet of material, is made of vaporized dulled-aluminum coating layers, and wherein the first, third, and fifth sheets of material are made of polyethylene terephthalate

According to still further features in the described preferred embodiment the first sheet of material and the fourth sheet of material's thickness values are at least 10 microns, and at most 20 microns.

According to still further features in the described preferred embodiment the method further including the step of: (i) carry baggage on the window shade device.

According to still further features in the described preferred embodiment the method further including the step of: (j) closing the lid.

According to another preferred embodiment of the present invention there is provided a method of preventing greenhouse effect inside vehicle including the steps of: (a) providing the user with a sun sleet brella, the sun sleet brella including: (i) first window shade device, and second window shade device, wherein each of the window shade devices includes: (A) a thin multiple-ply sheet for a window shade device having a first geometric axis and a second perpendicular geometric axis, having a self-rolling capability, having four sides, having an upper surface and a bottom surface, which substantially blocks the passage of solar radiation in the ranges of ultraviolet and visible light, wherein the thin multiple-ply sheet includes: (I) a first sheet of material, having a thickness value, having homogenous first tension in the first geometric axis direction, and having homogenous second tension in the second geometric axis direction; and (II) a second sheet of material, having a thickness value substantially connected to the first sheet of material having homogenous first tension in the first geometric axis direction, and having homogenous second tension in the second geometric axis direction, wherein the first tension of the first sheet of material is substantially identical to the first tension of the second sheet of material, and wherein the second tension of the first sheet of material is larger than the second tension of the second sheet of material; (III) a third sheet of material, having a thickness value, substantially connected to the second sheet of material, having an external surface; (IV) a fourth sheet of material, having a thickness value, substantially connected to the first sheet of material, having an external surface; and (V) a layer of an anti-UV compound, disposed on the third sheet of material's upper surface; (B) a container containing the thin multiple-ply sheet enabling pulling part of the sheet from and returning the sheet into the container by self-rolling including: (I) walls granting the container the form of an elongated cylinder; and (II) an axis disposed within the container, upon which the thin multiple-ply sheet is rolled; (C) at least one arm, wherein the arm enables the connection of the container to a vehicle; (D) at least one connector, disposed on the thin multiple-ply sheet, wherein the connector enables the thin multiple-ply sheet to grip the vehicle; and (E) a lid connected to the container enabling opening and closing of the container, wherein the form of the lid suits the form of the container and wherein when the lid is closed it applies force to the thin multiple-ply sheet, preventing the possibility of the force of wind pulling the sheet out of the container; (ii) a rotary connector, wherein the rotary connector enables the connection of first the window shade device to the second window shade device; (b) connecting the sun sleet brella to a vehicle, outside of the vehicle; (c) pulling the thin multiple-ply sheets from the containers and covering at least part of one of the vehicle's windows; (d) connecting the pulled ends of the thin multiple-ply sheets to the vehicle; (e) closing the lids with force over the pulled thin multiple-ply sheets; (f) opening the lids to a position enabling free motion of the thin multiple-ply sheets into the containers; (g) releasing the connections of the pulled end of the thin multiple-ply sheets from the vehicle; and (h) self-rolling of the thin multiple-ply sheets into the container, wherein the user applies restraining forces on the multiple-ply sheets to prevent rolling too fast; (i) folding the sun sleet brella; and (j) storing the sun sleet brella in the trunk of a vehicle.

According to still further features in the described preferred embodiment the second sheet of material is made of vaporized dulled-aluminum coating layers, and wherein the first, third, and fourth sheets of material are made of polyethylene terephthalate.

Following is a summarized list of the primary qualities of the window shade device according to the present invention:

It can be mounted on the outside of a vehicle.

It is very light in weight, namely a window shade device made for single directional coverage and its plastic housing combined, weigh less than a kilogram.

It can be constructed to cover one front windshield or a rear-window or constructed to cover the entire passenger compartment of a car.

The multiple-ply sheet rolls itself around an axis in the container, and when wound up, a 1.20 meter length of the multiple-ply sheet, together with the axis measures approximately 1.70 cm. in diameter. The container, which holds the handle and the coiled multiple-ply sheet and axis, is just a little larger than a standard roof rack, approximately 3.5 cm in diameter.

It is highly efficient in preventing the build-up of heat when the automobile covered with it is parked in the sun.

Because of its simplicity, the multiple-ply sheet can be drawn open and attached in a few seconds, and closed in a similar time.

It is engineered in such a manner that one single type model will be able to cover the majority of makes of cars world-wide.

It is manufactured of a small number of parts which, made in volume, allows for a low cost and low retail price.

It can be used as an ice-deflector.

It can be used to cover a myriad of different types of windows.

It can be constructed to be a combined baggage or ski roof-rack and shader.

It can be made to be attached to an existing roof rack, vertically or horizontally.

When there is no pre-existing roof rack, it can be made to be mounted on the roof of a car with its own set of feet.

The window shade device can be folded and stored in a car trunk without taking up a lot of space.

### BRIEF DESCRIPTION OF THE DRAWINGS

The invention is herein described, by way of example only, with reference to the accompanying drawings, wherein:

FIG. 1a of the prior art illustrates a car covered with a cover for the cab portion of the car.

FIG. 1b of the prior art illustrates a car covered with an environmental elements protector.

FIG. 1c of the prior art illustrates a car covered with a retractable vehicle cover.

FIG. 2a is a schematic illustration of a preferred embodiment of a multiple-ply sheet for a window shade device according to the present invention.

FIG. 2b is a schematic illustration of a y-y axis section of the multiple-ply sheet of FIG. 2a for a four-ply sheet configuration.

FIG. 3 is a schematic illustration of a preferred embodiment of a window shade device, partially covering a house window according to the present invention.

FIG. 4a is a schematic illustration of a preferred embodiment of a multiple-ply sheet for a window shade device according to the present invention, covering a rear window and side-door window of a pickup truck.

FIG. 4b is a schematic illustration of a preferred embodiment of a container of the multiple-ply sheet for a window shade device according to the present invention.

FIG. 5 is a schematic illustration of a preferred embodiment of a window sheet for a window shade device according to the present invention, covering the roof and all the windows of a sedan car.

FIG. 6 is a schematic illustration of a preferred embodiment of a window sheet for a window shade device according to the present invention, covering the front windshield of a sedan car.

FIG. 7 is a schematic illustration of a preferred embodiment of a window sheet for a window shade device according to the present invention, whose end is rolled around itself.

FIG. 8 is a schematic illustration of a preferred embodiment of a window sheet for a window shade device according to the present invention, connected to the roof rack of a vehicle.

FIG. 9 is a schematic illustration of a preferred embodiment of a window shade device according to the present invention with an aerodynamic structure.

FIGS. 10a, 10b, and 10c are schematic illustrations of a preferred embodiment of a window sheet for a window shade device according to the present invention, ensuring full coverage of a window that is not square or rectangular.

FIG. 11 is a schematic illustration of a preferred embodiment according to the present invention, showing two identical window shade devices connected back-to-back together and connected to the roof rack of a vehicle.

FIG. 12a is a schematic illustration of a preferred embodiment according to the present invention, showing two window shade devices connected one to the end of the other.

FIG. 12b is a schematic illustration of a preferred embodiment according to the present invention, showing the two identical window shade devices of FIG. 12a, in a configuration suitable for storage.

FIG. 13 is a schematic illustration of a preferred embodiment according to the present invention showing baggage being carried on a vehicle using two window shade devices.

FIG. 14 is a schematic illustration of a preferred embodiment of a window sheet for a window shade device according to the present invention covering the front windshield of a sedan car on the inside of the vehicle.

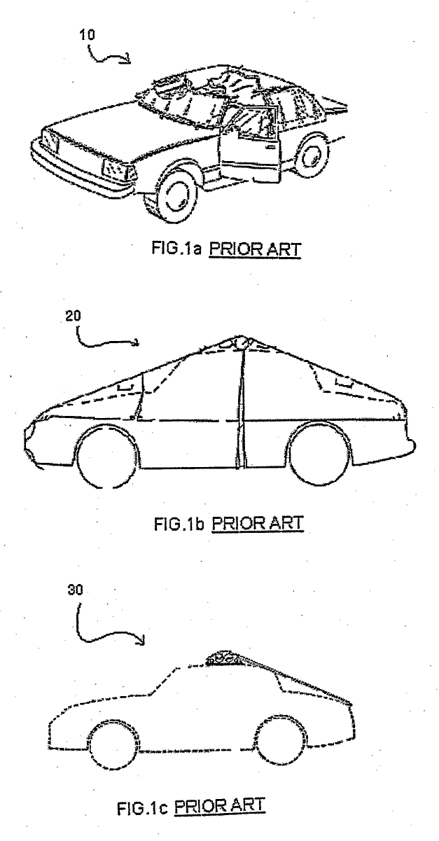

### DESCRIPTION OF THE PREFERRED EMBODIMENTS

The present invention is a window shade device, and in particular to a self-rolling vehicle window shade device.

The principles and operation of a shade device according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.

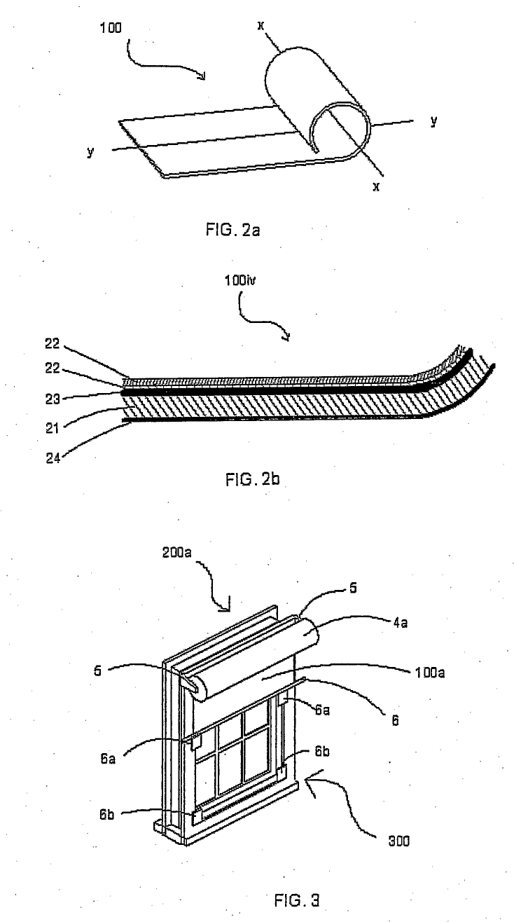

Referring now to the drawings, FIG. 2a is a schematic illustration of a preferred embodiment of a multiple-ply sheet 100 for a window shade device according to the present invention. The main component of the window shade device according to the present invention is a shading sheet with the required qualities including mechanical strength, low weight, good reflection of solar rays and self-rolling capability. These qualities are granted to the shading sheet 100 by its structure and manufacturing process.

The shading sheet is built as a multiple-ply sheet 100, with the plies composed of materials granting the necessary qualities and tension differences between plies that grant the self rolling capability, that enables self rolling around one axis, in a planar Cartesian axis system, seeing as the tension of the layers in the direction perpendicular to the axis is uniform and therefore the shading sheet has no self rolling quality in this direction.

FIG. 2b is a schematic illustration of a y-y axis section of the multiple-ply sheet 100 of FIG. 2a in a four-ply sheet 100iv configuration, which is one possible structure of many according to the present invention. The structure of the four-ply sheet 100iv includes one layer of PET (polyethylene terephthalate) 21, approximately 50 microns thick, upon which a vaporized dulled-aluminum coating layer 23 is attached, upon which is attached a pre-stretched layer of PET 22, approximately 12 microns thick, upon which is attached an additional pre-stretched layer of PET 22, approximately 12 microns thick. The use of vaporized dulled-aluminum coating layer 23 and not shiny aluminum is in order to avoid blinding light reflection.

Vaporized dulled-aluminum coating layer 23 is an ultra-thin layer with regard to the thickness of the layer of PET 22.

An anti-UV compound 24 can be sprayed to provide added solar protection to shield the car and lengthen the life of the multiple-ply sheet 100iv. The coating with an anti-UV compound 24 can be done upon the layer of PET 21, as shown in the illustration or upon the external layer of PET 22.

The material referred to as PET is a common polymer known as Polyethylene Terephthalate, an organic material characterized by long chain-like molecules built up from many units, and is one of the most widely used industrial polyesters. PET has good barrier properties against oxygen and carbon dioxide. Therefore, it is utilized in bottles for mineral water and other applications.

An example of a manufacturing process of the multiple-ply sheet can includes the following steps:

Spraying a PET sheet of 50 microns (or PET sheet of similar thickness such as 60, or 70 microns) with an anti-UV compound (e.g. Tinovine);

The PET sheet of 50 microns is laminated to a stretched PET sheet of 12 microns (or PET sheet of similar thickness);

After curing for one week, the two laminated sheets of PET are laminated to another stretched PET sheet of 12 microns;

Before beginning the above lamination processes, one or two of the above sheets will have been processed in advance to have a vaporized dulled-aluminum coating layer attached to it;

The resulting sheet is cut to desired size;

Heating of the resulting pieces of sheet at a temperature of 120° C. for fifteen minutes; and

Quickly cooling off and tightly winding into rolled position.

The spraying of the anti-UV compound provides added solar protection to shield the car and lengthen the life of the sheeting.

The vaporized dulled-aluminum coating layer is used in order to avoid a sharp glaring effect from the sun.

The completed material, ready for use in the designated product, has the properties of being self rolling, is opaque, and is highly effective in reflecting the sun's heat and UV rays. Other thicknesses of PET may be used, such as 40, 60, or 70 microns, in combination with the stretched PET12 or other thicknesses of PET. Other types of plastic materials can be combined in order to achieve the self-rolling effect, such as a combination of stretched PET with nylon and/or polypropylene.

As used herein the specification and in the claims section that follows, the term “vaporized dulled-aluminum coating layer” and the like refer to a coating layer of substantially dulled-aluminum produced in a vaporized vacuum process, whose result is a covering coating layer of pure aluminum that has uniform qualities, that grant the entire coating layer uniform tension and structural integrity, with high quality grip on the PET layer, and long term preservation of its qualities even during exposure to harsh weather conditions.

FIG. 3 is a schematic illustration of a preferred embodiment of a window shade device 200a partially covering a house window 300 according to the present invention. Window shade device 200a includes a container 4a from which multiple-ply sheet 100a is pulled, to the bottom of which a rod 6 and arms 5 are connected, connecting container 4a to the windowsill or wall of the house.

Connecting means 6a, which can also be “Velcro” strips, magnets, strips with buttons, etc., are connected to rod 6 by suitable devices 6b on the windowsill, the wall, or any other suitable place, in order to hold multiple-ply sheet 100a in open position.

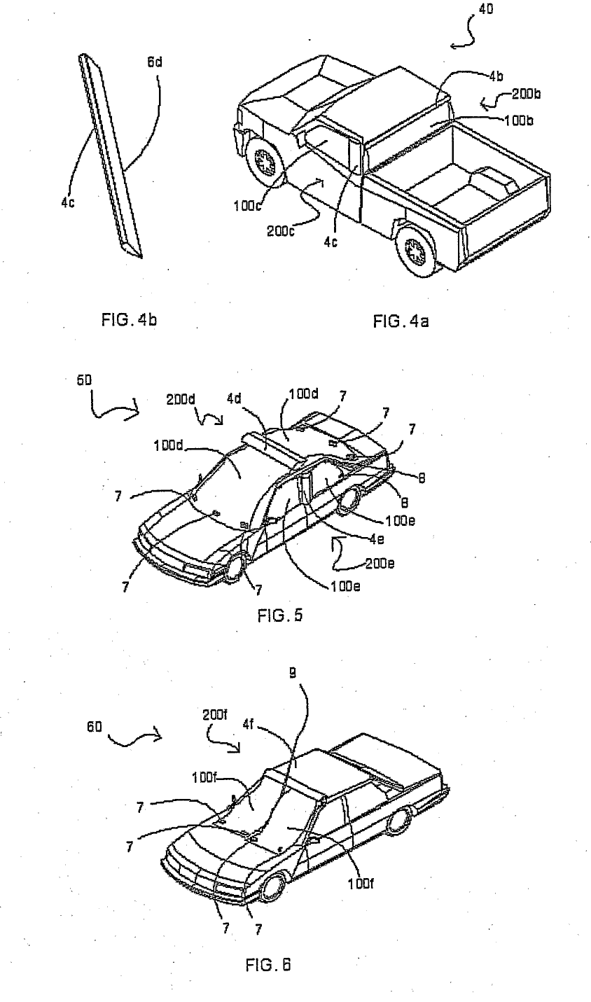

FIG. 4a is a schematic illustration of a preferred embodiment of multiple-ply sheets 100b and 100c for window shade devices 200b and 200c according to the present invention covering the rear window and side-door window of a pickup truck 40. Window shade device 200b includes a container 4b, connected to pickup truck 40 approximately horizontally, above and outside of the rear window frame, from which multiple-ply sheet 100b is pulled. Window shade device 200c includes container 4c, connected to pickup truck 40 approximately vertically, outside of the rear of the left door window frame, from which multiple-ply sheet 100c, whose shape is fitted to the shape of the window, is pulled.

FIG. 4b is a schematic illustration of a preferred embodiment of a container 4c of the multiple-ply sheet for a window shade device according to the present invention. The illustration shows a thin magnetic sheet 6d connected to a side of container 4c. This device enables easily attaching (and easily removing) the container 4c to the side of a vehicle in any desired place inside or outside the vehicle (provided that the sides of the vehicle are of a suitable material). To prevent theft, a strip can be extended from container 4c to the space between the door and the door-frame.

FIG. 5 is a schematic illustration of a preferred embodiment of multiple-ply sheets 100d and 100e for a window shade devices 200d and 200e according to the present invention, includes a containers 4d and 4e, covering the roof and all the windows of a sedan car. Container 4d is assembled over the roof of the car approximately horizontally, and two multiple-ply sheets 100d can be pulled from it, one for the rear window and one for the front windshield. The ends of these sheets are attached to the car with connectors, in this case with magnets 7. Additional connecting means can be “Velcro” strips attached under the front hood and extended to be attached to the Velcro strip attached to the end of the handle, or plastic hooks, or simply held in place by the windshield wipers. Multiple-ply sheets 100d designated for covering the rear window can be attached by having “Velcro” glued to the underside at the top of the baggage lid.

Container 4e is assembled to the side of the car approximately vertically between both side doors, and two multiple-ply sheets 100e can be pulled from it. Container 4e is held in the vertical by strips coming from the container and held in place between the two side doors and the posts. The strips are concealed in the illustration by multiple-ply sheets 100e.

The ends of these sheets are attached to the car with connectors, in this case with “Velcro” strips 8, with “Velcro” strips previously attached to the car in the corresponding places. Window shade device 200d with only one multiple-ply sheet 100d can be used for the front or rear of a vehicle. If two such window shade devices 200d are put back to back on top of the car in the center of the roof, the front windshield, rear window, and the roof can be covered. Just a few different widths, perhaps three (1.20, 1.30, 1.40 meters), would suffice to cover almost all vehicles manufactured in the world. Also the basic window shade device 200d can be standing on its own feet, or attached to a roof rack.

FIG. 6 is a schematic illustration of a preferred embodiment of a multiple-ply sheet for a window shade device 200f according to the present invention, covering the front windshield of the sedan car. Container 4f is assembled to the roof of the car approximately horizontally, in the front of the roof above the front windshield, and two multiple-ply sheets 100f are pulled from it, each of both covering part of the front windshield. This division enables avoiding the antenna 9 and also makes the pulling process easier, particularly for people of smaller sizes. Multiple-ply sheet for a window shade device 200f according to the present invention can be used to cover the rear window of a car or any other window.

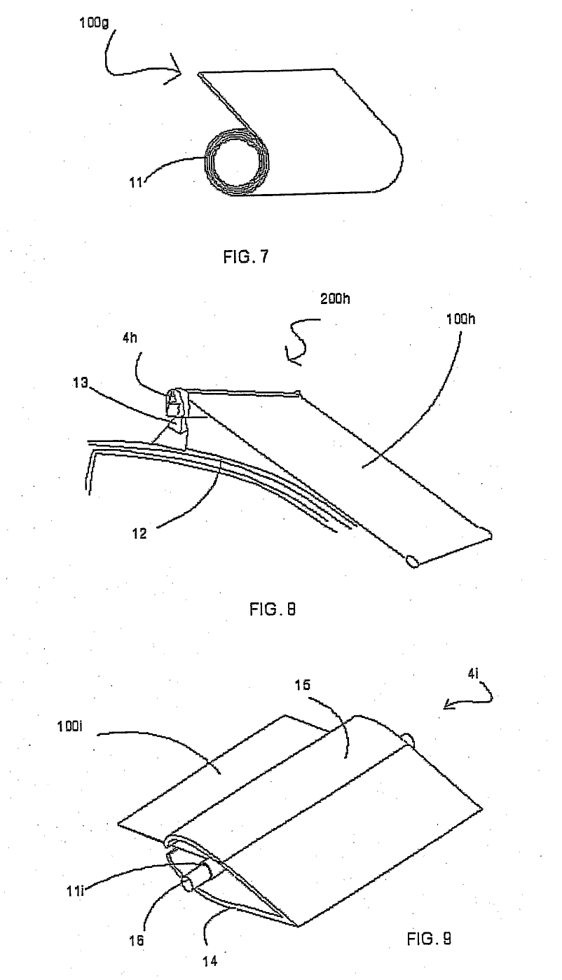

FIG. 7 is a schematic illustration of a preferred embodiment of a multiple-ply sheet 100g according to the present invention, whose end is rolled around itself several times. Rolling and attaching the plies in the area of the rolled end creates a cylinder 11i, which can serve at the designated end to be pulled as a rod along the width of the multiple-ply sheet 100g, of certain endurance against bending and a cylinder spinning around an axis on the other end. Furthermore, a cylinder 11i can be manufactured, similar to the opposite end of multiple-ply sheet 100g that will be used later on to rotate around the axis in the storage container. The typical circumference of cylinder 11i at the end to be pulled can be approximately 4 millimeters and the typical circumference of the cylinder including the entire multiple-ply sheet 100g in rolled position can be approximately 15 millimeters.

FIG. 8 is a schematic illustration of a preferred embodiment of a multiple-ply sheet 100h for a window shade device 200h according to the present invention that is connected to a standard roof rack 12 of a vehicle, by arm 13, that can be a simple standard connector, clamp, or bracket serving for connecting a vehicle roof carrier, connected both to the rack 12 and to container 4h of the window shade device 200h from which the multiple-ply sheet 100h is pulled.

FIG. 9 is a schematic illustration container 4i of a preferred embodiment of a window shade device according to the present invention, with an aerodynamic structure. This aerodynamic structure ensures that the aerodynamic resistance of the container 4i will be as low as possible and the flow of air around it will be turbulence-free and noiseless. The selected aerodynamic structure can be of any known shape, or can be tested in wind tunnel experiments, so that the drag coefficient of the container 4i will be no more than 0.1 when the container 4i is assembled to a vehicle moving forward. Container 4i has an elongated container with sides 14, containing multiple-ply sheet 100i, most of which is rolled onto an axis 16. Its internal end can be in the form of a cylinder 11i as described in FIG. 7. When multiple-ply sheet 100i is released from grip, it self-rolls easily, to being entirely rolled around axis 16. In order to prevent damage to multiple-ply sheet 100i as a result of rolling too fast, the release will usually be accompanied by the activation of a restraining force by the user, a force that will control the rolling speed. Typical time intervals for full opening as well as replacing into the container 4i of the multiple-ply sheet 100i are approximately 20 seconds. The direction of self-rolling of the multiple-ply sheet 100i can be such that the open part on the upper part of the cylinder is formed when rolling or unrolling. A certain part of the container 4i serves as a lid 15. Lid 15 can, when closed, press on multiple-ply sheet 100i with sufficient force to prevent further pulling from the container 4i.

This kind of pulling could occur when the vehicle is parked as described, and a strong wind is blowing. If the pulling is not prevented, multiple-ply sheet 100i could be further pulled out and could blow in the wind like a sail, and this is clearly undesirable.

It is possible to leave an extra multiple-ply sheet 100i length on the container-rod, in order to enable the length of the multiple-ply sheet 100i to cover cars that are either small or large.

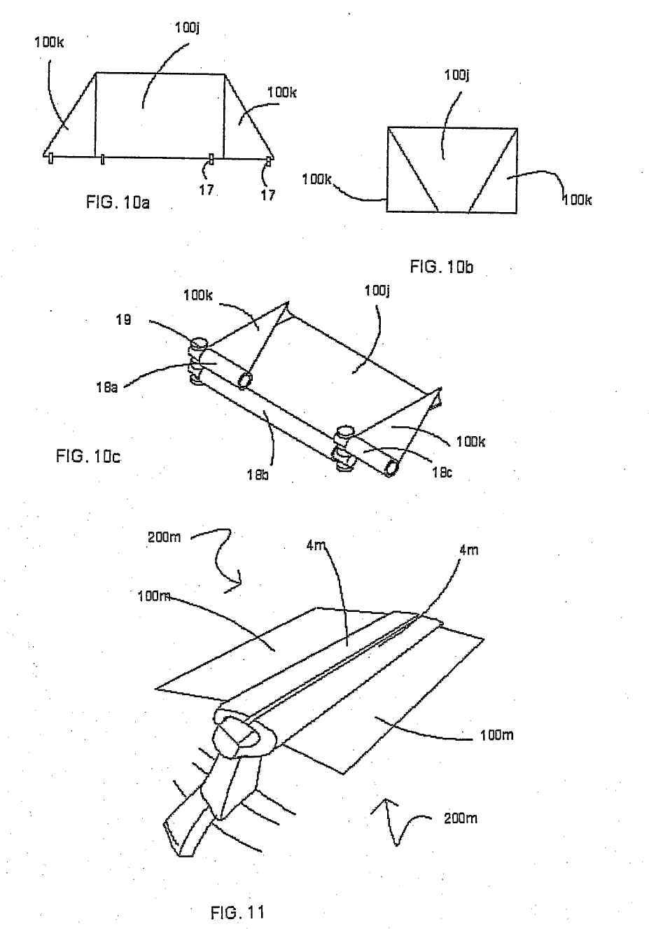

FIGS. 10a, 10b, and 10c are schematic illustrations of a preferred embodiment of a multiple-ply sheet 100j for a window shade device according to the present invention, ensuring full coverage of windshields that are neither square nor rectangular. In almost all cases the windshield of a vehicle is wider at the bottom than at the top. This preferred embodiment of a multiple-ply sheet 100j is not limited just to full coverage of windshields, but is also suitable for any other window that is not rectangular, of any type of vehicle, such as boating vessels and aircraft, as well as those of stationary structures.

FIG. 10a shows multiple-ply sheet 100j, whose width dimension suits the upper side width of the frame of the windshield that it is designated to cover. This width also dictates the width of the window shade device container so that it is no wider than the roof of the vehicle to which it is assembled. When covering a windshield that is wider at the bottom with a rectangular multiple-ply sheet 100j, the remainders on both sides can be approximately triangular areas, which remain exposed to solar radiation and/or accumulation of ice, according to circumstances. Testing has shown that this kind of exposure is sufficient to create greenhouse effect and raise the temperature within the vehicle to undesirably high levels. Therefore, according to the present invention, two multiple-ply sheets 100k are added to either side of multiple-ply sheet 100j, as shown in the figure, and are suitable in shape and size to cover the remaining exposed parts of the windshield. Prior to enabling multiple-ply sheet 100j to self roll into the container, multiple-ply sheets 100k are folded over multiple-ply sheet 100j, as shown in the FIG. 10b. Multiple-ply sheets 100k can be of the same plies as multiple-ply sheet 100j, namely can have self-rolling quality. Multiple-ply sheets 100k self-rolling direction needs to be inverse to the self-rolling direction of multiple-ply sheet 100j when spread open. As shown in FIG. 10c, the end of multiple-ply sheet 100j that is pulled can be connected to a central strengthening rod 18b. The connection is similar to what is shown in FIG. 7, with the pulled end rolled around itself for at least one whole rotation and is then attached to rod 18b. In a similar manner, the ends of multiple-ply sheets 100k are also connected to side strengthening rods 18a and 18c. Each of the side strengthening rods 18a and 18c is connected to the central strengthening rod 18b by means of an axle 19 enabling rotational movement of the rods with regard to each other. The illustration shows a position in which one multiple-ply sheet 100k is open while the other multiple-ply sheet 100k is folded. Addition of strengthening rods 18a, 18b, and 18c grants high durability to multiple-ply sheet 100j and to multiple-ply sheets 100k to withstand wind when open on a vehicle. The circumference of strengthening rods 18a, 18b, and 18c can be chosen according to the forces that they must endure the material of which they are composed, and the shape of their lateral cross section, that can be a full circular section, a circular section in the external circumference such as that of a pipe, a flat rectangular section, or any other suitable section.

Not unlike the various possibilities for connection the pulled ends as described in previous illustrations, multiple-ply sheet 100j and multiple-ply sheets 100k can be connected to the vehicle when open on it by means of various connectors 17 such as magnets, Velcro, snaps, button, etc., as well as connection to the vehicle's windshield wipers.

The circumference of strengthening rods 18a and 18c can be smaller than the circumference than the circumference of strengthening rod 18b because of multiple-ply sheet 100k material on the rods.

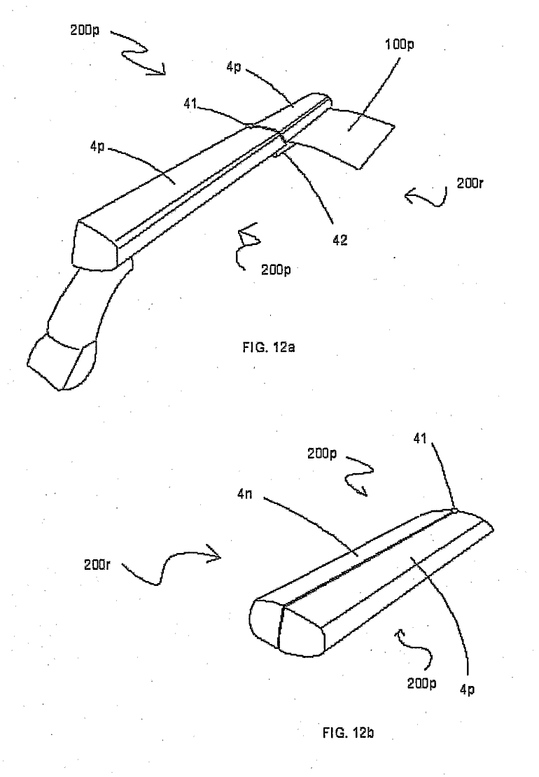

FIG. 11 is a schematic illustration of a preferred embodiment according to the present invention, showing two identical window shade devices 200m connected back-to-back together and connected to the roof rack of a vehicle. This connection configuration enables pulling a multiple-ply sheet 100m from each of the containers 4m and thus enables covering both the front and rear parts of the vehicle, as shown in FIG. 5, without any need for two window shade devices 200m of different structures. This enables manufacturing, marketing, and using universal window shade devices suitable for connection to nearly all types of vehicles available.

FIG. 12a is a schematic illustration of a preferred embodiment according to the present invention, showing two window shade devices 200p whose containers 4p are connected one to the end of the other. The connection can be by means of any standard connector known to one ordinarily skilled in the art. The illustration shows a rotary connector including an axis 41 that enables rotational movement between two containers 4p and a clasp 42 preventing this rotational movement when closed. The illustration show one multiple-ply sheet 100p in pulled position. The advantage of this configuration is granting a suitable form of storage for window shade device 200p within the vehicle, such as in the trunk or in any other place, as well as easy carrying by the user's hand.

As used herein the specification and in the claims section that follows, the term “sun sleet brella” and the like refer substantially to two window shade devices 200p whose containers 4p are connected to each other. The sun sleet brella is shown in the illustration as 200r. The sun sleet brella can be stored, during travel, in the trunk of a car, and after parking the car, can be pulled out of the trunk, spread out and easily assembled within a short period of time onto the car, and then the multiple-ply sheets 100p can be pulled from it and used to cover part of the car. Similarly, prior to driving, the sun sleet brella can be easily removed from the car, folded, and stored once again in the car trunk.

FIG. 12b is a schematic illustration of a preferred embodiment according to the present invention, showing the two identical window shade devices 200p of FIG. 12a, in a position suitable for storage.

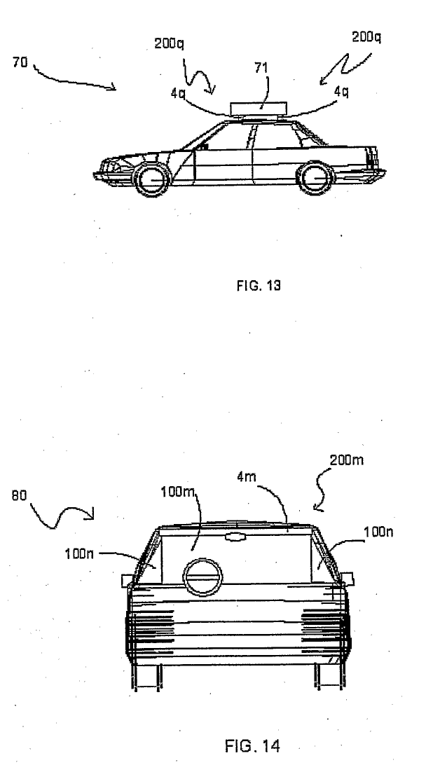

FIG. 13 is a schematic illustration of a preferred embodiment according to the present invention showing baggage being carried on the roof of a vehicle using two window shade devices 200q. Both containers 4q have a mechanical structure of suitable strength to carry the baggage 71.

FIG. 14 is a schematic illustration of a preferred embodiment of multiple-ply sheets 100m and 100n for a window shade device 200m according to the present invention covering the front windshield of a sedan car 80 on the inside of the vehicle.

All of the vehicle's windows can be covered on the inside in a similar manner.

Testing was performed on a vehicle equipped with a window shade device according to the present invention, based on the concept of shading the cabin of a car from the outside by using a highly effective aluminum coated sun and UV blocking material which is also self-rolling. By covering the cabin, it was found to be sufficiently effective to cover all the windows and roof of the vehicle. On checking comparative solutions available, the window shade device was found to block out up to 80% of heat build-up in a vehicle compared to 5-10% for the other methods available.

Testing was performed on the performance of the window shade device according to the present invention, in comparison with a fully exposed car parked in the sun and also comparing these results against two other window shade devices. The testing was done in Israel, at the beginning of March. In Israel, in March, the shade temperatures are usually in the lower or mid 20° C. The car was parked in the sun when the temperature high of the day was 22° C. and within 2 hours was found to have reached 50° C. and was still getting hotter. The testing was done on an aluminum colored four door sedan and an effectively aluminum colored reflective material was used in all the experiments. The testing was repeated several times. The results were recorded such that each of the vehicles' temperatures was compared to the result of the same vehicle being parked in the sun without any sun-shield and for the same period of time. The final figures obtained were the average high of each day, which was about 54° C. By covering the car from the outside with the window shade device according to the present invention, the result was a reduction of the heat accumulation by 80%. The temperature inside the car went up 5.5° C. in contrast with a 25.5° C. increase in a car parked fully exposed in the sun. By using the same covering material but covering the windows from the inside, the result was a 40% reduction in heat accumulation. The temperature in the car went up 16° C. in contrast with a 26° C. increase in a fully exposed car. A front sun-deflector managed to reduce the temperature by only 3%, reducing the inside temperature by only 1° C. Even though the steering wheel did not heat up, the front sun-deflector does not block the vehicle from heat build-up. Even in mild moderate temperatures such as 20° C.-24° C., cars heat up significantly. They also heat up very quickly. Within 10 minutes of standing in the sun the temperature goes up 5° C.-6° C. and within an hour 15° C. -17° C. When a car is left standing in the sun for, say six hours, the maximum temperature caused by greenhouse effect is usually reached within 3 hours and after that the car will not heat up significantly more, unless the shade temperature rises. The fact that many millions of windshield sun deflectors and side window shades are sold each year is an indication that masses of people are searching for a solution to cool their cars. Surprisingly, a dark colored car will heat just a little more than a light colored car. In 32° C. shade temperature in the summer, a car can heat up to 70° C. In areas with high humidity the effect is similar to a sauna.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A thin multiple-ply sheet for a window shade device having a first geometric axis and a second perpendicular geometric axis, having a self-rolling capability, having an upper surface and a bottom surface which substantially blocks the passage of solar radiation in the ranges of ultraviolet and visible light, the multiple-ply sheet comprising:
(a) a first sheet of material, having a thickness value, having homogenous first tension in said first geometric axis direction, and having homogenous second tension in said second geometric axis direction; and
(b) a second sheet of material, having a thickness value substantially connected to said first sheet of material having homogenous first tension in said first geometric axis direction, and having homogenous second tension in said second geometric axis direction, wherein said first tension of said first sheet of material is substantially identical to said first tension of said second sheet of material, and wherein said second tension of said first sheet of material is larger than said second tension of said second sheet of material.

2. The thin multiple-ply sheet for a window shade device of claim 1, wherein said first tension of said first sheet of material is substantially zero.

3. The thin multiple-ply sheet for a window shade device of claim 1, further comprising:
(c) a third sheet of material, having a thickness value, substantially connected to said second sheet of material, having an external surface.

4. The thin multiple-ply sheet for a window shade device of claim 1, further comprising:
(d) a fourth sheet of material, having a thickness value, substantially connected to said first sheet of material, having an external surface; and
(e) a layer of an anti-UV compound, disposed on said third sheet of material's external surface.

5. The thin multiple-ply sheet for a window shade device of claim 1, further comprising:
(d) a fourth sheet of material, having a thickness value, substantially connected to said first sheet of material, having an external surface; and
(e) a layer of an anti-UV compound, disposed on said fourth sheet of material's external surface.

6. The thin multiple-ply sheet for a window shade device of claim 3, wherein said third sheet of material's having a thickness value is at least three times larger than said first sheet of material's a thickness value.

7. The thin multiple-ply sheet for a window shade device of claim 4, wherein said second sheet of material, is made of a vaporized dulled-aluminum coating layer, and wherein said first, third, and fourth sheets of material are made of polyethylene terephthalate.

8. The thin multiple-ply sheet for a window shade device of claim 5, wherein said first sheet of material, and said fourth sheet of material's thickness value are at least 10 microns, and at most 20 microns.

9. A window shade device comprising:
(a) a thin multiple-ply sheet for a window shade device having first geometric axis and second perpendicular geometric axis, having self-rolling capability, having four sides, having an upper surface and a bottom surface, which substantially blocks the passage of solar radiation in the spectrum of ultraviolet and visible light, the multiple-ply sheet including:
(i) a first sheet of material, having thickness value, having homogenous first tension in said first geometric axis direction, and having homogenous second tension in said second geometric axis direction; and
(ii) a second sheet of material, having thickness value substantially connected to said first sheet of material having homogenous first tension in said first geometric axis direction, and having homogenous second tension in said second geometric axis direction, wherein said first tension of said first sheet of material is substantially identical to said first tension of said second sheet of material, and wherein said second tension of said first sheet of material is larger than said second tension of said second sheet of material;
(iii) a third sheet of material, having a thickness value, substantially connected to said second sheet of material, having an external surface;
(iv) a fourth sheet of material, having a thickness value, substantially connected to said first sheet of material, having an external surface; and
(v) a layer of an anti-UV compound, disposed on said third sheet of material's external surface;
(b) a container containing said thin multiple-ply sheet and enabling pulling part of said sheet out, and returning said sheet into said container by self-rolling, including:
(i) walls granting said container the form of an elongated cylinder; and
(ii) an axis disposed within said container, on which said thin multiple-ply sheet is rolled.

10. The window shade device of claim 9 further comprising:
(c) at least one arm, wherein said arm enables the connection of said container to a stationary structure.

11. The window shade device of claim 9 further comprising:
(c) at least one connector, disposed on said thin multiple-ply sheet, wherein said connector enables said thin multiple-ply sheet to grip a vehicle; and
(d) a lid connected to said container enabling opening and closing of said container, wherein the form of said lid suits the form of said container and wherein when said lid is closed it applies force to said thin multiple-ply sheet, preventing the possibility of the force of wind pulling said sheet out of said container.

12. The window shade device of claim 9, wherein said aerodynamic drag coefficient, is at most 0.1, when said window shade device is assembled to a forward-moving vehicle.

13. The window shade device of claim 9, further comprising:
(e) a first additional thin multiple-ply sheet disposed on said thin multiple-ply sheet; and
(f) a second additional thin multiple-ply sheet disposed on said thin multiple-ply sheet, wherein the geometric shape of said thin multiple-ply sheet, said first additional thin multiple-ply sheet, and said second additional thin multiple-ply sheet, when open, is suitable for full coverage of a vehicle window and wherein the self-rolling direction of said first additional thin multiple-ply sheet, and second additional thin multiple-ply sheet, is inverse to the self-rolling direction of said thin multiple-ply sheet.

14. The window shade device of claim 9, wherein at least one side of said thin multiple-ply sheet has a cylindrical shape.

15. The window shade device of claim 9 further comprising:
(g) a central strengthening rod disposed on said thin multiple-ply sheet;
(h) a first side strengthening rod disposed on said first additional thin multiple-ply sheet; and
(i) a second side strengthening rod disposed on said second additional thin multiple-ply sheet.

16. The thin multiple-ply sheet of claim 9, wherein said first tension of said first sheet of material is substantially zero.

17. The thin multiple-ply sheet of claim 9, wherein said third sheet of material's a thickness value is at least three times larger than said first sheet of material's thickness value.

18. The thin multiple-ply sheet of claim 9, wherein said second sheet of material, is made of a vaporized dulled-aluminum coating layer, and wherein said first, said third, and said fourth sheets of material are made of polyethylene terephthalate.

19. The thin multiple-ply sheet of claim 9, wherein said first sheet of material, and said fourth sheet of material's thickness value are at least 10 microns, and at most 20 microns.

20. The window shade device of claim 9, wherein said thin multiple-ply sheet for a window shade device has a diameter, wherein said diameter is at most 17 millimeters, when said multiple-ply sheet is completely rolled around said axis and disposed within said container.

21. The window shade device of claim 9, wherein said window shade device has a mass, wherein said mass is at most 1 kilogram.

22. The window shade device of claim 9 further comprising:
(c) at least one rotary connector, wherein said rotary connector enables the connection of first said window shade device to a second window shade device.

23. The window shade device of claim 9 further comprising:
(c) at least one thin magnetic sheet, disposed on said container, wherein said thin magnetic sheet enables said container to grip a vehicle; and
(d) a lid connected to said container enabling opening and closing of said container, wherein the form of said lid suits the form of said container and wherein when said lid is closed it applies force to said thin multiple-ply sheet, preventing the possibility of the force of wind pulling said sheet out of said container.

24. A method of preventing greenhouse effect inside vehicles and buildings, comprising the steps of:
(a) providing a user with a window shade device including:
(i) a thin multiple-ply sheet for a window shade device having a first geometric axis and a second perpendicular geometric axis, having a self-rolling capability, having four sides, having an upper surface and a bottom surface, which substantially blocks the passage of solar radiation in the ranges of ultraviolet and visible light, wherein said thin multiple-ply sheet includes:
(A) a first sheet of material, having a thickness value, having homogenous first tension in said first geometric axis direction, and having homogenous second tension in said second geometric axis direction; and
(B) a second sheet of material, having a thickness value substantially connected to said first sheet of material having homogenous first tension in said first geometric axis direction, and having homogenous second tension in said second geometric axis direction, wherein said first tension of said first sheet of material is substantially identical to said first tension of said second sheet of material, and wherein said second tension of said first sheet of material is larger than said second tension of said second sheet of material;
(C) a third sheet of material, having a thickness value, substantially connected to said second sheet of material, having an external surface;
(D) a fourth sheet of material, having a thickness value, substantially connected to said first sheet of material, having an external surface; and
(E) a layer of an anti-UV compound, disposed on said third sheet of material's external surface;
(ii) a container containing said thin multiple-ply sheet enabling pulling part of said sheet from and returning said sheet into said container by self-rolling including:
(A) walls granting said container the form of an elongated cylinder; and
(B) an axis disposed within said container, upon which said thin multiple-ply sheet is rolled;
(iii) at least one arm, wherein said arm enables the connection of said container to a vehicle;
(iv) at least one connector, disposed on said thin multiple-ply sheet, wherein said connector enables said thin multiple-ply sheet to grip a vehicle; and
(v) a lid connected to said container enabling opening and closing of said container, wherein the form of said lid suits the form of said container and wherein when said lid is closed it applies force to said thin multiple-ply sheet, preventing the possibility of the force of wind pulling said sheet out of said container, when said vehicle is in parked position;
(b) connecting said window shade device to said vehicle, outside of said vehicle;
(c) pulling said thin multiple-ply sheet from said container and covering at least part of one of said vehicle's windows;
(d) connecting the pulled end of said thin multiple-ply sheet to a vehicle;
(e) closing said lid with force over said pulled thin multiple-ply sheet;
(f) opening said lid to a position enabling free motion of said thin multiple-ply sheet into said container;
(g) releasing the connection of the pulled end of said thin multiple-ply sheet from said vehicle; and
(h) self-rolling of said thin multiple-ply sheet into said container, wherein said user applies a restraining force to said multiple-ply sheet to prevent rolling too fast.

25. The method of claim 24, wherein said connector aerodynamic drag coefficient, is at most 0.1 when said window shade device is assembled to a forward-moving vehicle.

26. The method of claim 24, wherein said window shade device further comprising:
(vi) a first additional thin multiple-ply sheet disposed on said thin multiple-ply sheet; and
(vii) a second additional thin multiple-ply sheet disposed on said thin multiple-ply sheet, wherein the geometric shape of said thin multiple-ply sheet, said first additional thin multiple-ply sheet, and second additional thin multiple-ply sheet, when open, is suitable for full coverage of a vehicle window and wherein the self-rolling direction of said first additional thin multiple-ply sheet, and second additional thin multiple-ply sheet, is inverse to the self-rolling direction of said thin multiple-ply sheet.

27. The method claim 24, wherein at least one side of said thin multiple-ply sheet has a cylindrical shape.

28. The method of claim 24, wherein said window shade device further comprising:
(viii) a central strengthening rod disposed on said thin multiple-ply sheet;
(ix) a first side strengthening rod disposed on said first additional thin multiple-ply sheet; and
(x) a second side strengthening rod disposed on said second additional thin multiple-ply sheet.

29. The method of claim 24, wherein said first tension of said first sheet of material is substantially zero.

30. The method of claim 24, wherein said third sheet of material's thickness value is at least three times larger than said first sheet of material's thickness value.

31. The method of claim 24, wherein said second sheet of material, is made of vaporized dulled-aluminum coating layers, and wherein said first, third, and fifth sheets of material are made of polyethylene terephthalate

32. The method of claim 24, wherein said first sheet of material, and said fourth sheet Of material's thickness values are at least 10 microns, and at most 20 microns.

33. The method of claim 24, further comprising the step of:
(i) carrying baggage on said window shade device.

34. The method of claim 24, further comprising the step of:
(j) closing said lid.

35. A method of preventing greenhouse effect inside vehicle comprising the steps of:
(a) providing the user with a sun sleet brella, said sun sleet brella including:
(i) first window shade device, and second window shade device, wherein each of said window shade devices includes:
(A) a thin multiple-ply sheet for a window shade device having a first geometric axis and a second perpendicular geometric axis, having a self-rolling capability, having four sides, having an upper surface and a bottom surface, which substantially blocks the passage of solar radiation in the ranges of ultraviolet and visible light, wherein said thin multiple-ply sheet includes:
(I) a first sheet of material, having a thickness value, having homogenous first tension in said first geometric axis direction, and having homogenous second tension in said second geometric axis direction; and
(II) a second sheet of material, having a thickness value substantially connected to said first sheet of material having homogenous first tension in said first geometric axis direction, and having homogenous second tension in said second geometric axis direction, wherein said first tension of said first sheet of material is substantially identical to said first tension of said second sheet of material, and wherein said second tension of said first sheet of material is larger than said second tension of said second sheet of material;
(III) a third sheet of material, having a thickness value, substantially connected to said second sheet of material, having an external surface;
(IV) a fourth sheet of material, having a thickness value, substantially connected to said first sheet of material, having an external surface; and
(V) a layer of an anti-UV compound, disposed on said third sheet of material's upper surface;
(B) a container containing said thin multiple-ply sheet enabling pulling part of said sheet from and returning said sheet into said container by self-rolling including:
(I) walls granting said container the form of an elongated cylinder; and
(II) an axis disposed within said container, upon which said thin multiple-ply sheet is rolled;
(C) at least one arm, wherein said arm enables the connection of said container to a vehicle;
(D) at least one connector, disposed on said thin multiple-ply sheet, wherein said connector enables said thin multiple-ply sheet to grip to a vehicle; and
(E) a lid connected to said container enabling opening and closing of said container, wherein the form of said lid suits the form of said container and wherein when said lid is closed it applies force to said thin multiple-ply sheet, preventing the possibility of the force of wind pulling said sheet out of said container;
(ii) a rotary connector, wherein said rotary connector enables the connection of first said window shade device to said second window shade device;
(b) connecting said sun sleet brella to a vehicle, outside of said vehicle;
(c) pulling said thin multiple-ply sheets from said containers and covering at least part of one of said vehicle's windows;
(d) connecting the pulled ends of said thin multiple-ply sheets to a vehicle;
(e) closing said lids with force over said pulled thin multiple-ply sheets;
(f) opening said lids to a position enabling free motion of said thin multiple-ply sheets into said containers;
(g) releasing the connections of the pulled end of said thin multiple-ply sheets from said vehicle; and
(h) self-rolling of said thin multiple-ply sheets into said container, wherein said user applies restraining forces on said multiple-ply sheets to prevent rolling too fast;
(i) folding said sun sleet brella; and
(j) storing said sun sleet brella in the trunk of a vehicle.

36. The method of claim 35, wherein said second sheet of material is made of vaporized dulled-aluminum coating layers, and wherein said first, third, and fourth sheets of material are made of polyethylene terephthalate.
